(19) United States
(12) Patent Application Publication
(10) Pub. No.: US 2025/0261767 A1
(43) Pub. Date: Aug. 21, 2025

(54) AIR CELL AND AIR MATTRESS

(71) Applicant: Wellell Inc., New Taipei City (TW)

(72) Inventors: Yue-Yin CHAO, New Taipei City (TW); Sheng-Wei LIN, New Taipei City (TW)

(73) Assignee: Wellell Inc., New Taipei City (TW)

(21) Appl. No.: 19/011,916

(22) Filed: Jan. 7, 2025

(30) Foreign Application Priority Data
Feb. 21, 2024 (TW) 113106244

(51) Int. Cl. A47C 27/10; A47C 27/08

(52) U.S. Cl. CPC A47C 27/10; A47C 27/081

(57) ABSTRACT

An air cell and an air mattress are provided. The air cell includes two opposing cell walls. When the air cell is inflated, an upper surface is formed at a top edge of the cell walls. Moreover, the air cell has a joining line extending along the top edge, which can be formed by joining the cell walls. The joining line has two semi-arc joining surfaces through arrangement of a wall junction position. In addition, the air mattress includes a plurality of air cells, a fluid generator, and a control system. The fluid generator is communicated with the air cells. The control system is configured to control the fluid generator to determine whether the air cells are inflated or deflated during use of the air mattress.

### CROSS-REFERENCE TO RELATED APPLICATION

This non-provisional application claims priority under 35 U.S.C. § 119(a) to Patent Application No. 113106244 filed in Taiwan, R.O.C. on Feb. 21, 2024, the entire contents of which are hereby incorporated by reference.

### BACKGROUND

### Technical Field

The disclosure relates to an air cell and an air mattress, and more particularly to an inflatable and deflatable air cell and a medical air mattress composed of a plurality of air cells.

### Related Art

For bedridden patients who are unable to move independently, prolonged lying in bed without proper repositioning or movement can result in pressure sores, due to constant pressure on the skin. This can cause discomfort and, in severe cases, endanger the patient's health. As a result, medical-grade air mattresses have been widely used in the healthcare industry. By controlling the pressure in the air cells of the mattress, the pressure between the patient's skin and the mattress (also known as interface pressure) can be maintained at an optimal level, preventing the skin or subcutaneous tissues from being subjected to long-term pressure in any particular posture. This helps ensure that blood circulation is not easily impeded, thereby preventing the formation of pressure sores.

The pressure relationship between a patient's skin and the mattress is influenced by several factors, one of which is the flatness of the lying surface. Common air mattresses are typically made of multiple oval-shaped air cells connected in parallel. The overall width of each air cell is difficult to maintain consistently during use, leading to possible gaps between them. Additionally, these oval-shaped air cells are processed using molds and high-frequency welding techniques, where the entire perimeter of the cell is welded in one step. This results in protrusions on both sides of the upper surface of the cell due to the side welds, which negatively affect the flatness of the mattress surface and the comfort of the patient lying on it. To address this issue, conventional technologies have introduced several internal straps, diaphragms, or similar elements along the length of the air cell. These elements are used to limit or maintain the width of the cell to prevent excessive expansion in the width direction after inflation, thus preserving the flatness of the top surface. However, the manufacturing process of such conventional techniques is complex, leading to high production costs.

### SUMMARY

In view of the above, the disclosure provides an air cell, including two cell walls opposing to each other. Each cell wall includes a top edge, a bottom edge and two side edges. When the air cell is inflated, an upper surface is formed along the top edges of the two cell walls. Moreover, the air cell further comprises a joining line extending along the direction of the top edges, which may be formed by directly joining the cell walls. The joining line includes at least two semi-arc joining surfaces.

In some embodiments, the air cell may further include a first air chamber and a second air chamber that are adjacent to each other and separated by the joining line. A maximum inflation volume of the first air chamber may be less than a maximum inflation volume of the second air chamber. The first air chamber may be a space defined by the upper surface, the joining line, and the two side edges. The second air chamber may be a space defined by the joining line, the bottom edge, and the two side edges.

In some embodiments, the joining line may include a central arc segment, and the central arc segment may include a central apex. A distance between the central apex and the upper surface may be less than a distance between the central apex and the bottom edge.

In some embodiments, the semi-arc joining surfaces may be arranged at two ends of the central arc segment respectively, and each semi-arc joining surface may include a semi-arc edge which may be curved toward the upper surface.

In some embodiments, the joining line may further include two longitudinal inclined segments and two transverse flat segments. One end of each of the longitudinal inclined segments may be connected to two ends of the central arc segment respectively, and the longitudinal inclined segments are gradually widen toward the upper surface. Additionally, one end of each of the transverse flat segments may be respectively connected to the other ends of the longitudinal inclined segments respectively, and the other ends of the transverse flat segments may extend toward the two side edges respectively.

In some embodiments, the joining line may further include a plurality of arcuate bending segments, which may be respectively located between the longitudinal inclined segments and the central arc segment and between the longitudinal inclined segments and the transverse flat segments.

In some embodiments, each of the two cell walls may be trapezoidal, and a length of the top edge of each cell wall may be greater than a length of the bottom edge.

In some embodiments, two side ends of the upper surface may each include a folded corner part bending from a longitudinal direction of the upper surface and towards the bottom edge, and the folded corner parts may each include a folded corner joining line, which may extend in a width direction of the upper surface.

The disclosure provides an air mattress, includes a plurality of the air cells, a fluid generator and a control system. The fluid generator is in fluid communication with the air cells. The control system is electrically connected to the fluid generator and configured to control the fluid generator to regulate inflation or deflation of the air cells during use of the air mattress.

In some embodiments, the air cells may each include at least one first air cell and at least one second air cell. Two ends of the joining line of each first air cell are connected to two side edges of the two cell walls respectively. Two ends of the joining line of each second air cell are respectively at a specific distance from the two side edges of the two cell walls.

### BRIEF DESCRIPTION OF THE DRAWINGS

FIG. 1 is a three-dimensional view of an air cell according to some embodiments of the disclosure;

FIG. 2 is a front view of the air cell shown in FIG. 1;

FIG. 3A is a sectional view taken along line AA in FIG. 2;

FIG. 3B is a sectional view taken along line BB in FIG. 2;

FIG. 3C is a sectional view taken along line CC in FIG. 2;

FIG. 4 is a front view of an air cell according to some embodiments of the disclosure;

FIG. 5 is a three-dimensional partial view of an air mattress according to some embodiments of the disclosure; and

FIG. 6 is a system architecture diagram of an air mattress according to some embodiments of the disclosure.

### DETAILED DESCRIPTION

Various embodiments are provided below for detailed description. However, the embodiments are merely used as examples and will not limit the scope of protection of the disclosure. In addition, some components are omitted from the drawings in the embodiments to clearly show the technical characteristics of the disclosure. Furthermore, like reference numerals will be used to represent the same or similar components in all drawings. The drawings in the disclosure are merely for illustrative purposes and are not necessarily drawn to scale, and not all the details are necessarily presented in the drawings.

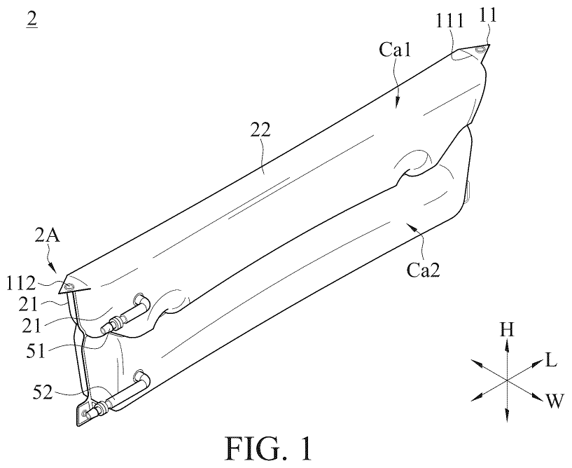

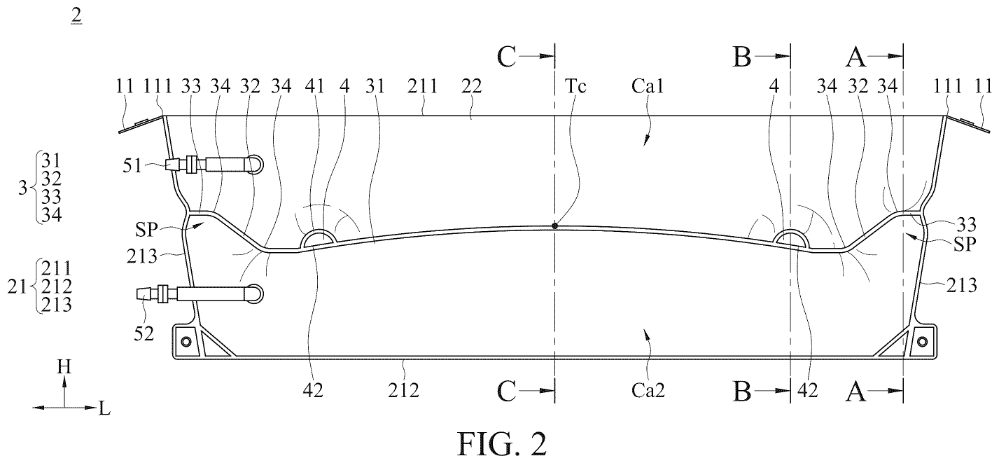

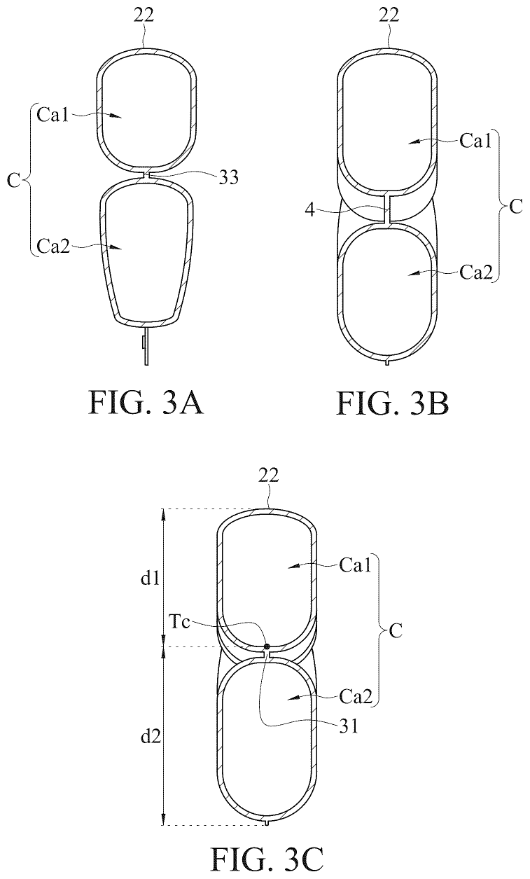

Referring to FIG. 1, FIG. 2 and FIG. 3A to FIG. 3C, FIG. 1 is a three-dimensional view of an air cell according to some embodiments of the disclosure, FIG. 2 is a front view of the air cell shown in FIG. 1, and FIG. 3A to FIG. 3C respectively show sectional views taken along line AA, line BB and line CC in FIG. 2. As shown in the figures, the air cell 2 includes two cell walls 21 opposing to each other, and each cell wall 21 includes a top edge 211, a bottom edge 212 and two side edges 213. However, when the air cell 2 is inflated, an upper surface 22 is formed along the top edges 211 of the two cell walls 21, and the upper surface 22 is the surface that directly or indirectly contacts a user.

Additionally, as shown in the figures, the air cell 2 has a joining line 3 extending along the top edges 211, which extends along a longitudinal direction L of the upper surface 22. The joining line 3 is formed by directly joining the cell walls 21. The joining line 3 separates the top edge 211 from the bottom edge 212 in a height direction H of the air cell 2. The joining line 3 has at least two semi-arc joining surfaces 4.

Further, the two cell walls 21 may be formed by bending a single air cell fabric into a U shape and then performing high frequency welding or other joining method, thereby forming the bottom edge 212, the two side edges 213, and the joining line 3. Additionally, in some embodiments, the bottom edge 212, the two side edges 213, and the joining line 3 at once using high frequency welding in a mold (not shown). In other embodiments, the air cell 2 may also be formed by welding a plurality of pieces of air cell fabrics, for example, by joining two pieces of air cell fabric together.

In some embodiments, the top edge 211, the bottom edge 212 and the two side edges 213 form a sealed cell chamber C through high frequency welding, and the joining line 3 divides the sealed cell chamber C into a first air chamber Ca1 and a second air chamber Ca2. In the embodiment shown in FIG. 1, FIG. 2 and FIG. 3A to FIG. 3C, the first air chamber Ca1 and the second air chamber Ca2 are adjacent to each other but are not interconnected. The maximum inflation volume of the first air chamber Ca1 is less than a maximum inflation volume of the second air chamber Ca2. As shown in the figures, the first air chamber Ca1 is defined by the space bounded by the upper surface 22, the joining line 3, and the two side edges 213. The second air chamber Ca2 is defined by the space bounded by the joining line 3, the bottom edge 212, and the two side edges 213.

In the embodiment presented in these figures, two independent air chambers which can be inflated and deflated respectively are used. The first air chamber Ca1 may be inflated and deflated through a first valve 51, and the second air chamber Ca2 may be inflated and deflated through a second valve 52. In some embodiments, by inflating or deflating the first air chamber Ca1, for example but not limited to periodic inflation or deflation, it can provide the user with the effect of promoting blood circulation and preventing the formation of bedsores. In addition, the second air chamber Ca2 can provide basic cushioning and support, preventing discomfort from the user's body directly contacting the hard bed frame during downtime.

Referring to FIG. 1 and FIG. 2, as shown in these figures, two side ends of the upper surface 22 each include a folded corner part 11, which is bended from a longitudinal direction L of the upper surface 22 towards the bottom edge 212. The folded corner part 11 contains a folded corner joining line 111 and a buckle 112. The folded corner joining line 111 extends in a width direction of the upper surface 22. The buckle 112 may be fixed to a fixing assembly (not shown) at an edge of a bed.

In some embodiments, the folded corner part 11 may be triangular. The folded corner part 11 may be welded again to form the folded corner joining line 111 after the welding lines such as the top edge 211, the bottom edge 212, the two side edges 213, and the joining line 3 are formed. The folded corner joining lines 111 are located at the two side ends of the upper surface 22, and each have a length almost the same as a width of the upper surface 22. Accordingly, the folded corner part 11 can be used to eliminate protrusions formed by the welding lines at the side edges 213 on two sides of the upper surface 22.

On the other hand, after the folded corner part 11 is fixed to the fixing assembly (not shown) at the edge of the bed through the buckle 112, it can stretch the entire top surface 22, thereby further maintaining the flatness of the top surface 22. Moreover, since the formation of the folded corner part 11 will reduce a length of the top edge 211, in some embodiments, the two cell walls 21 may be shaped as trapezoids, where the length of the top edge 211 may be greater than a length of the bottom edge 212. Accordingly, after the formation of the folded corner part 11, the trapezoidal configuration of the cell walls 21 can still maintain the substantially rectangular shape of the air cell 2.

Referring to FIG. 2 and FIG. 3C together, the joining line 3 includes a central arc segment 31, which is curved toward the upper surface 22 and may have a radius of curvature between 500 mm and 4000 mm, preferably between 1000 mm and 3500 mm, and more preferably between 1500 mm and 3000 mm. The radius of curvature used depends entirely on the size and desired degree of support of the air cell 2. Further, the central arc segment 31 may have an effect of limiting a volume of the first air chamber Ca1. The smaller the radius of curvature, the stronger the limiting effect, resulting in greater support in the height direction H of the air cell 2. Specifically, in some embodiments, supporting force in the height direction H may be provided by the second air chamber Ca2, and moreover, the upwardly curved central arc segment 31 can also be used to enhance the upward supporting effect. For example, the central arc segment 31 can support a middle part of the upper surface 22 of the air cell 2 to make it flat.

Additionally, as shown in the figures, the central arc segment 31 includes a central apex Tc, and a distance d1 between the central apex Tc and the upper surface 22 is less than a distance d2 between the central apex Tc and the bottom edge 212. The shorter the distance between the central arc segment 31 and the upper surface 22, the more pronounced the supporting effect the central arc segment 31 provides to the top surface 22 in the height direction H. In other words, the supporting effect generated by the upward curved central arc segment 31 in the height direction H is strongest in the middle of the central apex Tc, with the support gradually weakening toward both sides. This helps address the common issue in conventional air bladders where the midsection of the upper surface 22 tends to sag due to lower internal pressure and insufficient support.

Referring to FIG. 2 and FIG. 3B together, as shown in the figures, two ends of the

central arc segment 31 are each provided with one semi-arc joining surface 4. In some embodiments, the semi-arc joining surface 4 may be a semi-circular welding surface, which is formed by welding the two cell walls 21 and may be formed simultaneously with the joining line 3. Moreover, the semi-arc joining surface 4 includes a semi-arc edge 41 and a flat lower edge 42. The semi-arc edge 41 is curved toward the upper surface 22, and the flat lower edge 42 is directly connected to the central arc segment 31. Therefore, orientations of the semi-arc joining surfaces 4 also slightly widens toward the two side edges 213 respectively following to the curvature of the central arc segment 31.

Accordingly, the semi-arc joining surface 4 can have a limiting effect on the first air chamber Ca1 in a width direction W, that is, it can be used to reduce a width of the inflated first air chamber Ca1, especially at positions corresponding to the two semi-arc joining surfaces 4. In this way, an overall width of the air cell 2 to be maintained substantially consistent. In addition, in some embodiments, the semi-arc joining surface 4 may also be used to regulate air volumes of the first air chamber Ca1 and the second air chamber Ca2, ensuring that the air volume of the first air chamber Ca1 is less than the air volume of the second air chamber Ca2. In other words, a position, size and shape of the semi-arc joining surface 4 are closely related to the width of the inflated air cell 2.

However, the semi-arc joining surface 4 is not limited to being connected to the joining line 3, and its shape of the semi-arc joining surface 4 is not limited to a semicircular shape. The size of the semi-arc joining surface 4 may also be set according to actual needs. In other words, in other embodiments, the position, shape and size of the semi-arc joining surface 4 may be changed according to actual needs, such as adjusting the position, shape, and size of the semi-arc joining surfaces 4 according to the actual pattern, degree, and position of the bulge formed in the width direction W after the air cell 2 is inflated.

Referring to FIG. 1, FIG. 2 and FIG. 3A, as shown in the figures, the joining line 3 further includes two longitudinal inclined segments 32, two transverse flat segments 33, and four arcuate bending segments 34. One ends of each of the two longitudinal inclined segments 32 are connected to two ends of the central arc segment 31 respectively, and the longitudinal inclined segments gradually widen towards the upper surface 22. One end of each of the two transverse flat segments 33 is respectively connected to the other ends of the two longitudinal inclined segments 32 respectively, and the other ends of the two transverse flat segments extends toward the two side edges 213 respectively and are connected to the two side edges 213. Additionally, there is a arcuate bending segment 34 is located between the longitudinal inclined segment 32 and the central arc segment 31, as well as between the transverse flat segment 33 and the longitudinal inclined segment 32, such that the entire joining line 3 presents a smooth U-shaped joining line.

In other words, the joining line 3 formed by the two transverse flat segments 33, the two longitudinal inclined segments 32, four arcuate bending segments 34 and the central arc segment 31 can strengthen the connection between the first air chamber Ca1 and the second air chamber Ca2. Besides, in this way, a supporting part SP may be formed near each of the two side edges 213 to improve the supporting effect on the first air chamber Ca1 and prevent the first air chamber Ca1 from swaying easily. On the other hand, when the first air chamber Ca1 is deflated, a local supporting effect can still be provided through the supporting parts SP on the two sides of the second air chamber Ca2.

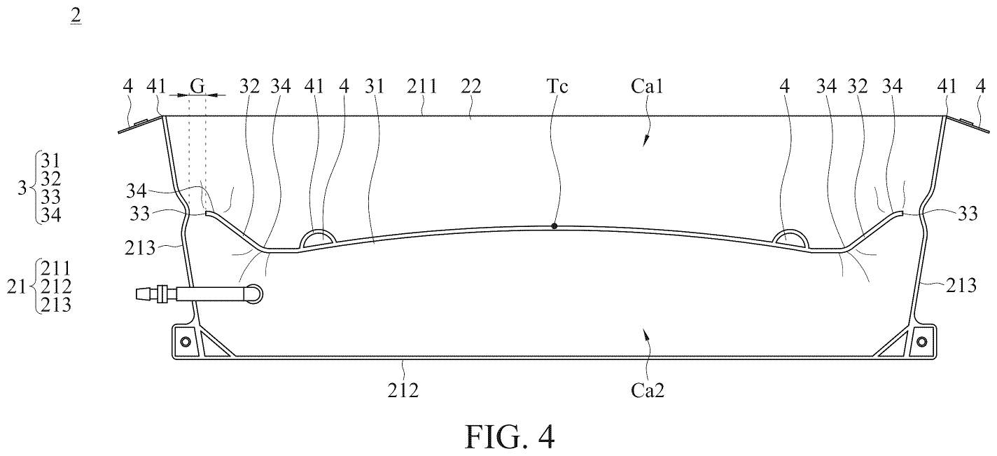

Referring to FIG. 4, it is a front view of the air cell 2 according to some embodiments of the disclosure. In the embodiment shown in FIG. 4, two ends of the joining line 3 are respectively spaced apart from the two side edges 213 of the two cell walls 21 by a specific distance G, that is, the two ends of the joining line 3 are not connected to the side edges 213 of the two cell walls 21. In other words, the first air chamber Ca1 and the second air chamber Ca2 are interconnected. Accordingly, when the air cell 2 is inflated, both the first air chamber Ca1 and the second air chamber Ca2 will be filled with air at the same time. Similarly, when the air cell 2 is deflated, both the first air chamber Ca1 and the second air chamber Ca2 will be deflated at the same time. The air cell 2 of this form may be arranged at positions to support smaller weight, such as the head, neck and lower limbs of the human body.

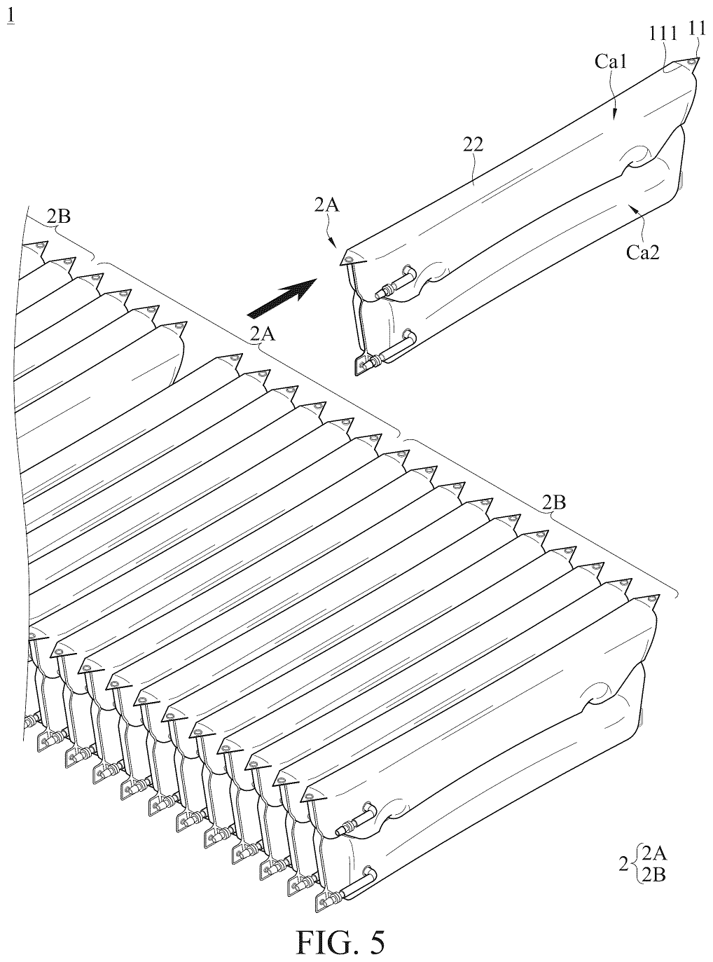

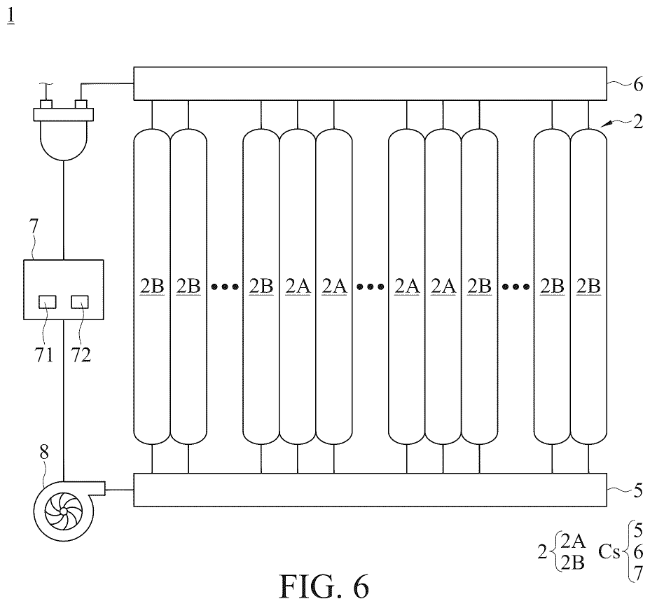

Referring to FIG. 5 and FIG. 6 together, FIG. 5 is a three-dimensional partial view of an air mattress 1 according to some embodiments of the disclosure, and FIG. 6 is a system architecture diagram of the air mattress 1 according to some embodiments of the disclosure. As shown in these figures, the air mattress 1 includes a plurality of air cells 2, a fluid generator 8, and a control system Cs. The control system Cs is electrically connected to the fluid generator 8. The control system Cs is configured to control the fluid generator 8 to regulate inflation or deflation of the air cells 2 during use of the air mattress 1.

In some embodiments, the air cells 2 may include a plurality of first air cells 2A and a plurality of second air cell 2B. The first air cell 2A can adopt the air cell 2 shown in FIG. 1, FIG. 2 and FIG. 3A to FIG. 3C, wherein the first air chamber Ca1 and the second air chamber Ca2 are independent air chambers which can be inflated and deflated respectively. The second air cell 2B may be the air cell 2 shown in FIG. 4, wherein the first air chamber Ca1 and the second air chamber Ca2 are interconnected. Accordingly, in some embodiments, the first air cell 2A can be configured at a position corresponding to a body trunk portion that bears a heavier weight, while the second air cell 2B can be configured at a position corresponding to a portion that bears a lighter weight, such as the human head, neck, and lower limbs

Additionally, as shown in FIG. 6, in some embodiments, the control system Cs may include an inflation module 5, a deflation module 6, and a control module 7. The inflation module 5 is fluidly connection to the fluid generator 8, and the two are configured to inflate the air cells 2. In some embodiments, the inflation module 5 may include a plurality of fluid solenoid valves, a plurality of manifold assemblies, a plurality of pipes, and connectors (not shown). The plurality of fluid solenoid valves may be electrically connected to the control module 7, and the fluid solenoid valves can fluidly connect to the air cells 2 through the manifold assemblies, the pipes, and the connectors.

In some embodiments, each air cell 2 or each air chamber may be provided with one fluid solenoid valve (not shown) to allow for individual inflation control of each air cell 2 or each air chamber. However, it is not limited to the fluid solenoid valve, and in other embodiments, a flow proportional valve, a pneumatic solenoid valve, or other fluid valve controllable by the control module 7 may also be employed. In addition, in other embodiments, a single fluid solenoid valve may be configured for multiple air cells 2 to enable synchronous inflation of those air cells 2.

In some embodiments, the fluid generator 8 may deliver gas to the air cells 2 at different pressures and flow rates based on different needs of the air mattress 1. For example, the fluid generator 8 may be configured as a blower to deliver gas at a relatively low pressure and a relatively high flow rate. In another embodiment, the fluid generator 8 may also be configured as a gas compressor to deliver gas at a relatively low flow rate and a relatively high pressure.

In addition, in some embodiments, the deflation module 6 may also include a plurality of fluid solenoid valves, a plurality of manifold assemblies, a plurality of pipes, and connectors (not shown). The plurality of fluid solenoid valves may be electrically connected to the control module 7, allowing the solenoid valves to establish fluid connections with the air cells 2 through the manifold components, pipes, and connectors.

In some embodiments, each air cell 2 or each air chamber may be provided with one fluid solenoid valve (not shown) to allow for individual inflation control of each air cell 2 or each air chamber. In other embodiments, the plurality of air cells 2 may also be provided with one fluid solenoid valve (not shown) such that the plurality of air cells 2 are deflated synchronously. Similarly, it is not limited to the fluid solenoid valves, and in other embodiments, a flow proportional valve, a pneumatic solenoid valve, or other fluid valve controllable by the control module 7 may also be employed.

In some embodiments, the control module 7 may include a processor 71 and a memory 72. The memory 72 may be configured to store a plurality of instructions that are executable by the processor 71. The instructions may instruct the control module 7 to actuate the fluid generator 8 and the fluid solenoid valve in the inflation module 5, so as to allow gas to be delivered to the air cells 2 and even control each air cell 2 individually. In addition, the instructions may also instruct the control module 7 to actuate the fluid solenoid valves of the deflation module 6, so as to allow gas to be discharged from the air cells 2 and control deflation of respective air cells 2. The instructions may vary depending on the number of the fluid solenoid valves, the specifications of the fluid generator 8, the presence of a plurality of fluid generators 8, or other variables.

In other embodiments, the control module 7 may also implement various operating functions in the form of hardware circuits, and examples include, but are not limited to, a workstation, a laptop computer, a client terminal, a server, a distributed computing system, a handheld device, or any other arithmetic systems or devices.

Although the disclosure has been described in considerable detail with reference to certain preferred embodiments thereof, the disclosure is not for limiting the scope of the application. Persons having ordinary skill in the art may make various modifications and changes without departing from the scope and spirit of the disclosure. Therefore, the scope of the appended claims should not be limited to the description of the preferred embodiments described above.

What is claimed is:

1. An air cell, comprising:
two cell walls, opposing each other, each cell wall comprising a top edge, a bottom edge, and two side edges,
wherein when the air cell is inflated, an upper surface is formed along the top edges of the two cell walls; the air cell further comprises a joining line extending along the top edges, which is formed by directly joining the cell walls; the joining line includes at least two semi-arc joining surfaces.

2. The air cell according to claim 1, further comprising a first air chamber and a second air chamber that are adjacent to each other and separated by the joining line, wherein a maximum inflation volume of the first air chamber is less than a maximum inflation volume of the second air chamber; the first air chamber is a space defined by the upper surface, the joining line, and the two side edges; and the second air chamber is a space defined by the joining line, the bottom edge, and the two side edges.

3. The air cell according to claim 1, wherein the joining line comprises a central arc segment, and the central arc segment comprises a central apex; and a distance between the central apex and the upper surface is less than a distance between the central apex and the bottom edge.

4. The air cell according to claim 3, wherein the semi-arc joining surfaces are respectively arranged at two ends of the central arc segment, and each semi-arc joining surface comprises a semi-arc edge which is curved toward the upper surface.

5. The air cell according to claim 3, wherein the joining line further comprises two longitudinal inclined segments and two transverse flat segments; one end of each of the two longitudinal inclined segments is connected to two ends of the central arc segment respectively, and the longitudinal inclined segments are gradually widens toward the upper surface; and one end of each of the two transverse flat segments is respectively connected to the other ends of the two longitudinal inclined segments, and the other ends of the two transverse flat segments extends toward the two side edges.

6. The air cell according to claim 5, wherein the joining line further comprises a plurality of arcuate bending segments, which are respectively located between the two longitudinal inclined segments and the central arc segment, and between the two longitudinal inclined segments and the two transverse flat segments.

7. The air cell according to claim 1, wherein each of the two cell walls is trapezoidal, and a length of the top edges is greater than a length of the bottom edge.

8. The air cell according to claim 1, wherein two side ends of the upper surface each comprise a folded corner part, bending from a longitudinal direction of the upper surface and towards the bottom edge; and the folded corner parts each comprise a folded corner joining line, which extends in a width direction of the upper surface.

9. An air mattress, comprising:
a plurality of the air cells according to claim 1;
a fluid generator, in fluid communication with the air cells; and
a control system, electrically connected to the fluid generator, wherein the control system is configured to control the fluid generator to regulate inflation or deflation of the air cells during use of the air mattress.

10. The air mattress according to claim 9, wherein the air cells comprise at least one first air cell and at least one second air cell; two ends of the joining line of each first air cell are respectively connected to the two side edges of the two cell walls; and two ends of the joining line of each second air cell are respectively at a specific distance from the two side edges of the two cell walls.
